(19) United States
(12) Patent Application Publication
(10) Pub. No.: US 2011/0110541 A1
(43) Pub. Date: May 12, 2011

(54) ELECTROMAGNETIC TRANSDUCTION ACOUSTIC BRIDGE AND RELATED METHODS

(76) Inventors: Claude Annie Perrichon, L'Isle d'Abeau (FR); Francois Giry, Challes les Eaux (FR); Jose Buendia, Bourgoin-Jallieu (FR); Pierre Piccaluga, Macon (FR)

(21) Appl. No.: 12/672,481

(22) PCT Filed: Mar. 10, 2008
(86) PCT No.: PCT/FR08/00307

§ 371 Date: Jan. 24, 2011

(51) Int. Cl. H04R 17/00

(52) U.S. Cl. 381/190

(57) ABSTRACT

An electromagnetic transduction acoustic bridge appliance may include an electro-acoustic transducer including a housing, and a coil carried by the housing, and a piezoelectric paste adjacent the electro-acoustic transducer and including metallic powder embedded therein for picking up audio information of a magnetic field lost from the coil. The electromagnetic transduction acoustic bridge appliance may include a link coupling the piezoelectric paste to the housing. The piezoelectric paste may form an acoustic bridge for picking up the audio information and transmitting the audio information to the housing using the link.

### FIELD OF THE INVENTION

The present invention relates to the field of electromagnetism, and, more particularly, to piezoelectric devices and related methods.

### BACKGROUND OF THE INVENTION

This patent application is an improvement of international patent application No. FR2008/000273, filed on Mar. 3, 2008, and No. PCT/FR 2007/001353, filed Aug. 8, 2007. The generality of the functions of the electronic component called eCRT® (electron Converter in Real Time) is claimed on the basis of the three simultaneous activities interlinked in this electronic component that are described hereinbelow, which extend the amplification of acoustic application.

### SUMMARY OF THE INVENTION

An aspect of the invention is directed to an electromagnetic transduction acoustic bridge appliance that may include an electro-acoustic transducer including a housing, and a coil carried by the housing, and a piezoelectric paste adjacent the electro-acoustic transducer and including metallic powder embedded therein for picking up audio information of a magnetic field lost from the coil. The electromagnetic transduction acoustic bridge appliance may include a link coupling the piezoelectric paste to the housing. The piezoelectric paste may form an acoustic bridge for picking up the audio information and transmitting the audio information to the housing using the link.

Another aspect is directed to a method that may comprise picking up audio information of an electromagnetic field lost by coils of at least one electro-acoustic transducer using an electron Converter in Real Time (eCRT) mass adjacent a support of the at least one electro-acoustic transducer. The method may include transmitting the audio information to a soundboard formed by at least the support of the at least one electro-acoustic transducer, and adding a complement of the audio information for providing sound richness amplified by sound propagation over a surface of the support using the eCRT mass for picking up the magnetic losses converted into acoustic vibrations.

### DETAILED DESCRIPTION OF THE PREFERRED EMBODIMENTS

The method of the eCRT electronic component, which absorbs magnetic charges through the powdered metallic material included in the piezoelectric component is vital to audio applications. It may serve as an acoustic amplifier based on sound propagation resonance when it is directly placed on a mass used as a soundboard. The eCRT mass becomes and assumes the characteristics of a musical instrument bridge, which picks up and transmits all the sound vibrations. The eCRT function is an electrically unconnected external function which cleans the magnetic sound information charge lost by the coils of the acoustic transducers then absorbed by the metallic powder charge. The introduction of copper, gold, iron or metal powder into the piezoelectric component makes it possible to convert the magnetic charge into an electrical information charge, which is immediately transformed into mechanical motions. The metal can be in the form of small magnetic loops of a few turns, 1, 2 or 3, to pick up the magnetic field of the lost acoustic sound information and transform it into electrical current.

From Applicants' experience, magnetic loops have not been used, but metal or aluminum powder have been used and, depending on the concentration, Applicants have recorded piezoelectric activity by the electric charge acquired in the powders or the loops. A mini-coil (a magnetic loop with powder) allows for small optimization of the effects. However, a loop demands a specific resonance frequency and amplitude, which limits the picking-up of all the frequencies and amplitudes. Powder with a certain density and concentration in the mixture of the paste of the piezoelectric material, makes it possible to receive almost all the frequencies and amplitudes, without being specially tuned. The powder makes it possible to have an overall effect sensitive to all the magnetic charge information working around the eCRT electronic component.

The technology refers to the energies of the weak links and to the Van der Walls dipoles, the Laplace, Hertz, Lorentz, Gauss, Maxwell and Faraday laws. The applications show a product with multiple applications that are managed by the eCRT component whose general applications are indicated in a non-exhaustive way.

The first application case is a particular case, which is the sound application, and relates to the present application. The magnetic loss of loudspeakers is a loss of acoustic efficiency of the coils that we recover for the sound activity through the lost mechanical vibration of the membranes, sound mechanical vibration that is retrieved by the present method. The eCRT electronic component is a regulator that, like entropy, regulates natural balance exchanges of information from electromagnetic charges with electrical charges. This balance is to naturally clean the air and excess magnetic charges around the eCRT appliances that are absorbed, attracted and picked up by the trap of the metallic components. Nanotechnology makes it possible to see the migration of the magnetic fields converted into electric current with which the piezoelectric material is supplied to vibrate. These functions are all natural but, when linked together, they create new functions specific to this process.

This nanotechnology vision makes it possible to resolve a large-scale approach. The sound application in the ambient space of the eCRT electronic component is the best demonstration of the audio magnetic loss picked up by the piezoelectric characteristics, which with metallic powder added pick up the magnetic field instantaneously and transform the magnetic information into electric current, according to the audio modulation. Using this audio electrical modulation and the transience of the piezoelectricity, the signals are transformed into audible mechanical movements of the sound initially lost by the coil. The lost harmonics are retrieved. This eCRT component appliance placed in front of an electro-acoustic loudspeaker restores the perception of the sound lost through the magnetic losses, affecting sound efficiency. The harmonics are given back in real time because the piezoelectric does not have mechanical inertia and retransmits the information in real time. The overall sound is raised from 1.5 to 7 dB in acoustic power with a richness and an unprecedented harmonic swell in direct natural listening.

The eCRT component also reduces the cross talk between the electromagnetic self-inductions. It is worth remembering the Teppaz from the 1960s, which revolutionized the distribution of sound with its diamonds. The piezoelectric cells of the Teppaz picked up the waves from the vinyl discs. This first piezoelectric application included the vibratory mechanical transposition into electric current. The present disclosure uses the reverse, which proceeds with a mechanical excitation, and obtains a current through the electromagnetic charge picked up remotely by the metallic powder or the metallic loops on the parts where the magnetic fluxes flow. The metallic powder and/or the magnetic loop is embedded, included in the piezoelectric paste, which can thus react instantaneously to the electric current that is picked up and that is diffused in the paste. The current picked up in this way activates the vibrations of the piezoelectric material. The eCRT electronic appliance has a mass and a number that are determined according to the spatiality and the acoustics desired by those skilled in the art and is applied rigidly to at least one wall of the support of one or more acoustic transducers.

These three functions of eCRT device are: magnetic field picked up by a loop and/or metallic powder; magnetic field transformed into electric current; and electric current transformed by the piezoelectric into mechanical vibration. These three functions are instantaneous, simultaneous, and natural.

This electronic component is a new generation of the possible processing of the three transformations into different information dimensions, firstly of an electronic kind, secondly of an electromagnetic kind, and thirdly of a mechanical kind. The applications of eCRT affect all the acoustic fields through its construction and its mechanical vibratory propagation functions in dynamic phase.

The appliances put in place are nonlimiting exemplary embodiments. The technology called eCRT fulfills the three functions that allow for an instantaneous servo-controlling of the audio information lost by the audio transducers. It is a component that acts in real time according to a number of functions acting and working in a holistic and instantaneous way, that is to say running in real time “T₀.” This technique complements the microprocessor techniques that act only according to an electrical function variable, a technique in which Moore's law through the addition of its functions, remains in a sectored binary plane, cannot access in instantaneous time and therefore remains at T-1.

The eCRT acts globally over the entire frequency band of the audio spectrum without special selection and is free of resonance. It is important to know that sound does not wait and that a note emitted is emitted with all its fundamental and harmonic structures, and that it is highly unrealistic to believe that one of the components may be processed separately from the others. This manipulation is a temporal diffraction that totally denatures the tone, the power and the sound signature emitted at an instant T₀. Putting in place the eCRT component resolves this fundamental issue of sound reproduction, which does not support any electronic delay effect. The musical vibratory application that is reconstructed, recovered by this eCRT electronic component, is of the same order as that of the bridge of a string instrument: violin, piano, etc. This vibratory information in real time adds a dynamic power by the addition of the lost harmonics that are complemented with the fundamentals and the first order harmonics, which also adds exceptional intelligibility with no effort. However, another sound range exists deriving from this recovery of magnetic information by the eCRT and demands to be expressed. Like a piano string or the string of any string instrument, the eCRT can be likened to an acoustic bridge that transmits the vibratory information that it receives and transposes it to a soundboard. This soundboard is made of musical reproduction material and is quite simply the resonance case of an acoustic chamber or the loudspeaker support.

For televisions, it is the support for the flat screen or the electronic tube. For telephone applications or auditory prostheses, it is the envelope itself that is used as a vibratory support. The sound vibratory conduction is done through the solid material by the elasticity of the materials, under tension or not. The mass of the eCRT is in direct contact with the material to be excited, which may amplify the sound vibrations like a tuning fork that is placed on a table or on any mass that amplifies the propagation of the sound through the surface resonance.

The quality and performance may depend on the effects to be obtained by those skilled in the art. One application that is extremely useful in the field of automobile, bus, truck, plane and boat transport is to put in place the mass of the eCRT applied directly to the structure of the dashboard or the walls of the cabins. The method comes into its own in that it is made possible by the mass of the eCRT and its three associated functions to transpose the lost magnetic information into audible mechanical mode. The fixing of the mass or masses of the eCRT by one or more of the rigid links described in a nonlimiting exemplary way as being formed by glue, screw, nail, jumper or by a rubber band, makes it possible to communicate the sound vibration to a soundboard.

The soundboard may emit the sound over the entire propagation surface of the support concerned. This support concerned can be a door upright or a dashboard or the support for the loudspeaker or loudspeakers that may propagate the sound. This acoustic signal originates from the coupling of the mass of the eCRT with a surface mechanical amplification of the material in which it is solidly implanted, which complements the sound richness and the sound dynamic range which increase by at least 1.5 dB and are increased with more of the appliances. These electromagnetic transduction bridges, with their at least one soundboard appliance constructed in this way, become fully-fledged electro-acoustic transducers and proceed naturally with the acoustic range that is useful for everyone involved in the audio and audiovisual fields. A variant of the appliance of the present method comprises an eCRT mass placed in proximity to one or more electro-acoustic transducers, and which is independent of the electro-acoustic transducer support or supports.

The appliance comprises the eCRT mass, which is trapped in at least one sound board. In this case, the soundboard comprises a double soundboard, including in a simple embodiment two planks (clamped sheets of wood held under tension at both ends, one against the other). The eCRT mass is jammed between the two sheets, the tension being adjusted by those skilled in the art. The sheets make it possible to place the mass of the eCRT close to the desired acoustic transducer. The sheets of wood are, in a nonlimiting exemplary embodiment, 50 centimeters long and 10 centimeters wide for a thickness of 3 millimeters. One or two clamping screws at each end of the sheets are used to adjust the tension. The positioning of the eCRT is, like the placement of a bridge on a violin, based upon the place where the resonance has the greatest effect, i.e. toward approximately one third of the overall length.

1-4. (canceled)

5. A method comprising:
picking up audio information of an electromagnetic field lost by coils of at least one electro-acoustic transducer using an electron Converter in Real Time (eCRT) mass adjacent a support of the at least one electro-acoustic transducer; and
transmitting the audio information to a soundboard formed by at least the support of the at least one electro-acoustic transducer; and
adding a complement of the audio information for providing sound richness amplified by sound propagation over a surface of the support using the eCRT mass for picking up the magnetic losses converted into acoustic vibrations.

6. The method according to claim 5 wherein the at least one electro-acoustic transducer comprises a loudspeaker.

7. An electromagnetic transduction acoustic bridge appliance comprising:
at least one electro-acoustic transducer including a housing, and coils carried by said housing; and
an electron Converter in Real Time (eCRT) paste adjacent said at least one electro-acoustic transducer and including metallic powder therein for picking up audio information of an electromagnetic field lost from said coils and converting the audio information first into an audio-electrical signal and second into an audible signal;
said eCRT paste forming an acoustic bridge for picking up the audio information via a link and transmitting the audio information to said housing via the link.

8. The electromagnetic transduction acoustic bridge appliance according to claim 7 wherein the metallic powder comprises at least one of copper powder and gold powder.

9. The electromagnetic transduction acoustic bridge appliance according to claim 7 further comprising a pair of sheets with said eCRT paste therebetween, and a plurality of screws for affixing said pair of sheets together and for positioning said eCRT paste.

10. The electromagnetic transduction acoustic bridge appliance according to claim 9 wherein said pair of sheets comprises a pair of wood sheets.

11. The electromagnetic transduction acoustic bridge appliance according to claim 7 wherein the link comprises at least one of a glue based link, a screw based link, a nail based link, a jumper based link, and a rubber band based link.

12. A transduction acoustic bridge appliance comprising:
at least one electro-acoustic transducer including a housing, and at least one coil carried by said housing;
a piezoelectric paste adjacent said at least one electro-acoustic transducer and including metallic powder therein for picking up audio information of an electromagnetic field lost from said at least one coil; and
a link coupling said piezoelectric paste to said housing;
said piezoelectric paste forming an acoustic bridge for picking up the audio information and transmitting the audio information to said housing using said link.

13. The transduction acoustic bridge appliance according to claim 12 wherein said at least one electro-acoustic transducer comprises a loudspeaker.

14. The transduction acoustic bridge appliance according to claim 12 wherein said piezoelectric paste comprises an electron Converter in Real Time (eCRT) paste.

15. The transduction acoustic bridge appliance according to claim 12 wherein the metallic powder comprises at least one of copper powder and gold powder.

16. The transduction acoustic bridge appliance according to claim 12 wherein said link comprises a pair of sheets with said piezoelectric paste therebetween, and a plurality of screws affixing said pair of sheets together and for positioning said piezoelectric paste; and wherein said pair of sheets are coupled to said housing.

17. The transduction acoustic bridge appliance according to claim 12 wherein the link comprises at least one of a glue based link, a screw based link, a nail based link, a jumper based link, and an elastic tension link based link.
